(19) United States
(12) Patent Application Publication
(10) Pub. No.: US 2011/0234085 A1
(43) Pub. Date: Sep. 29, 2011

(54) FIELD EMISSION DEVICE

(75) Inventors: Hyun-seung Cho, Anyang-si (KR); Jai-kyung Kim, Suwon-si (KR); Yong-gun Won, Suwon-si (KR); Seung-kwon Ryu, Suwon-si (KR); Dong-Su Chang, Suwon-si (KR)

(73) Assignee: SAMSUNG ELECTRONICS CO., LTD., Suwon-si (KR)

(21) Appl. No.: 13/050,999

(22) Filed: Mar. 18, 2011

(30) Foreign Application Priority Data
Mar. 24, 2010 (KR) 10-2010-0026410

(51) Int. Cl. H01J 63/04

(52) U.S. Cl. 313/496

(57) ABSTRACT

A field emission device including: a first substrate on which at least one gate electrode line, at least one cathode line, and at least one electron emission source are formed; a second substrate on which an anode and a phosphor layer are formed; a side frame which is interposed between the first substrate and the second substrate and surrounds an area between the first substrate and the second substrate to form a sealed internal space, wherein the first substrate is offset from the second substrate by a predetermined length in a first direction perpendicular to a direction in which the first substrate and the second substrate are spaced apart from each other by the side frame; a rear terminal part through which a voltage is applied to the gate electrode line and the cathode line, and which is formed on a protruding region of the first substrate protruding by the predetermined length; and an anode terminal part through which a voltage is applied to the anode, wherein the anode terminal has a first end which contacts the anode, and a second end which is exposed to outside of the side frame.

### CROSS-REFERENCE TO RELATED PATENT APPLICATION

This application claims the benefit of Korean Patent Application No. 10-2010-0026410, filed on Mar. 24, 2010, in the Korean Intellectual Property Office, the disclosure of which is incorporated herein in its entirety by reference.

### BACKGROUND

1. Field

Apparatuses consistent with exemplary embodiments relate to a field emission device that may be used in a field emission display device, a field emission-type backlight, and the like.

2. Description of the Related Art

Field emission devices (FEDs) emit light in such a way that electrons are emitted from an emitter formed on a cathode by a strong electric field formed around the emitter, and the emitted electrons are accelerated to collide with a phosphor layer formed on an anode.

FEDs may be used as display devices. In particular, a phosphor layer included in a FED is divided into pixel units and materials thereof are determined based on the pixel units so as to emit red, green, and blue lights respectively. In addition, FEDs control the emission of electrons from an emitter according to an image signal, thereby displaying images. Such FEDs may display color images with high resolution and high luminance even at minimum power consumption, and thus are expected to be display devices for the next generation.

In addition, FEDs may be used as backlights of non-emission-type display panels, such as liquid crystal panels. In general, cold cathode fluorescent lamps, which are linear light sources, and light emitting diodes, which are point light sources, have been used as light sources for backlights. However, such backlights generally have complicated structures, and the light sources are disposed at sides of the backlights, thereby consuming a large amount of power due to the reflection and transmission of light. In addition, when liquid crystal panels are manufactured in large sizes, it can be difficult to obtain uniform luminance. On the other hand, when field emission-type backlights are used as such backlights, they operate at lower power consumption than backlights using cold cathode fluorescent lamps or light emitting diodes, and may also exhibit relatively uniform luminance even in a wide range of emission areas.

### SUMMARY

One or more exemplary embodiments provide a field emission device having a structure in which non-emission areas may be decreased.

According to an aspect of an exemplary embodiment, there is provided a field emission device including a first substrate on which a gate electrode line, a cathode line, and an electron emission source are formed; a second substrate facing and spaced apart from the first substrate, and on which an anode and a phosphor layer are formed; and a side frame surrounding an area between the first substrate and the second substrate, and forming a sealed internal space, wherein the first substrate is offset from the second substrate by a predetermined length in a first direction perpendicular to a direction where the first substrate and the second substrate are spaced apart from each other, and a rear terminal part for applying a voltage to the gate electrode line and the cathode line is formed on a protruding region protruding by the predetermined length, wherein an end of an anode terminal part for applying a voltage to the anode contacts the anode, and the other end of the anode terminal part is exposed to the outside of the side frame.

The anode terminal part may have a structure of penetrating through the side frame.

The anode terminal part may include a contact plate contacting the anode; an internal pin connected to the contact plate; an anode pin formed of a flexible and conductive material, and of which end is connected to the internal pin, and penetrating through the side frame; and an external pin connected to the anode pin at the outside of the side frame.

The anode pin may include a dumet.

The contact plate may include a sus mesh.

A reinforcing glass member for protecting the external pin may be attached to an outer wall of the side frame.

The field emission device may further include a sus pipe surrounding the external pin.

The field emission device may further include a frit formed between the external pin and a portion of the anode pin that penetrates through the side frame to be exposed to the outside.

The anode terminal part may include a metal plate penetrating through a contact region between the side frame and the second substrate.

The side frame, the second substrate, and the metal plate may be fixedly attached to each other by the frit.

The field emission device may include a spacer for maintaining a space between the first substrate and the second substrate, wherein the metal plate is fixedly attached to the anode by the spacer.

The metal plate may be attached to the anode by a conductive adhesive.

The side frame, the second substrate, and the metal plate may be fixedly attached to each other by the frit. In addition, a surface black layer may be formed on a portion of the metal plate that contacts the frit.

A hole may be formed in a portion of the metal plate that is attached to the anode.

A longitudinal direction of any one of the gate electrode line and the cathode line is the first direction, and a longitudinal direction of the other thereof may be a second direction perpendicular to the first direction. In this case, the field emission device may further include a routing pattern for guiding any one of the gate electrode line and the cathode line towards the protruding region protruding by the predetermined length, wherein a longitudinal direction of the any one of the gate electrode line and the cathode line is the second direction.

The phosphor layer may include a phosphor material in which white light is excited by electrons emitted from the electron emission source. Alternatively, the phosphor layer may include a plurality of cell regions each including a phosphor material in which red light, green light, or blue light is excited by electrons emitted from the electron emission source.

### BRIEF DESCRIPTION OF THE DRAWINGS

The above and other features will become more apparent by describing in detail exemplary embodiments with reference to the attached drawings in which:

FIG. 1 is a schematic exploded perspective view of a field emission device according to an exemplary embodiment;

FIG. 2 is a partial perspective view illustrating detailed features of stacked structures formed on first and second substrates of the field emission device of FIG. 1;

FIG. 3 is a view illustrating an anode terminal part included in the field emission device of FIG. 1;

FIGS. 4, 5 and 6 are views illustrating structures of reinforcing portions of the anode terminal part of the field emission device of FIG. 1, wherein the portions of the anode terminal part are exposed to the outside;

FIG. 7 is a schematic exploded perspective view of a field emission device according to another exemplary embodiment; and

FIGS. 8 and 9 are partial cross-sectional views illustrating structures in which a metal plate included in the field emission device of FIG. 7 is attached to an anode.

### DETAILED DESCRIPTION OF EXEMPLARY EMBODIMENTS

Reference will now be made in detail to embodiments, examples of which are illustrated in the accompanying drawings, wherein like reference numerals refer to like elements throughout. In the drawings, the sizes of the elements may be exaggerated for clarity and convenience of explanation.

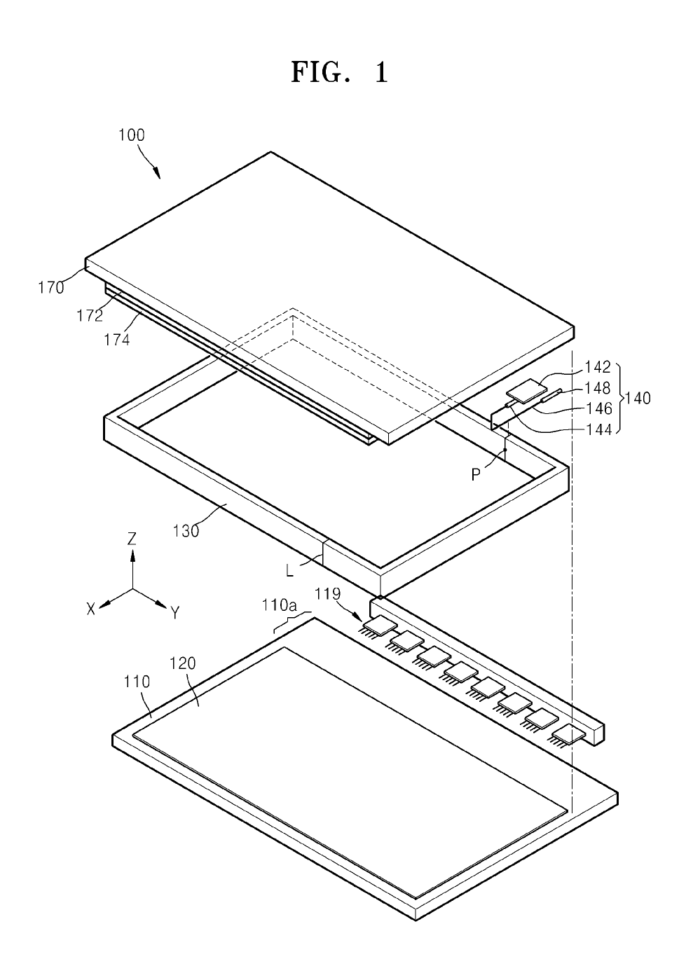

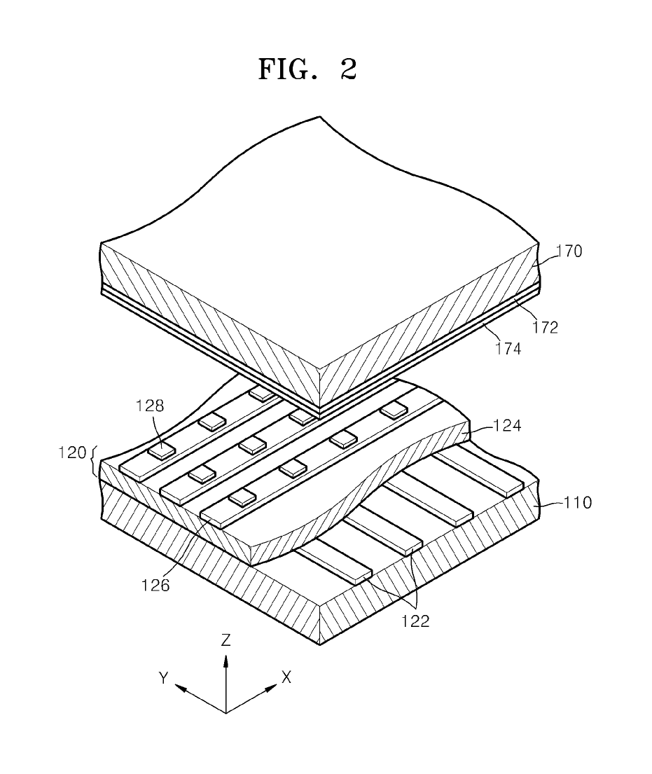

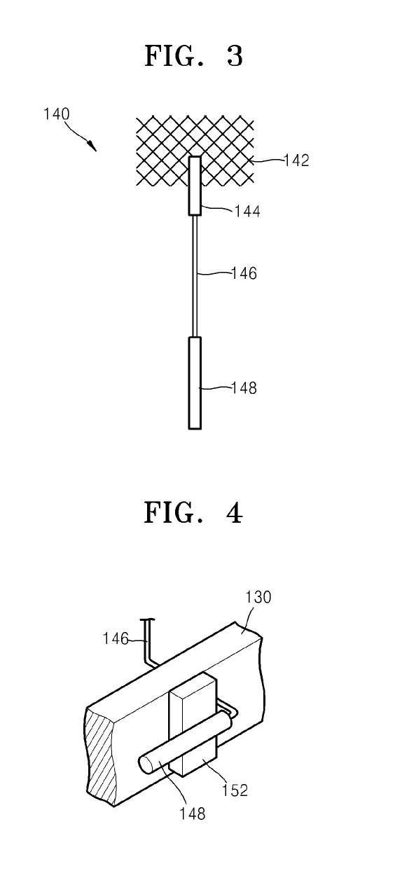

FIG. 1 is a schematic exploded perspective view of a field emission device 100 according to an exemplary embodiment. FIG. 2 is a partial perspective view illustrating detailed features of stacked structures formed on first and second substrates 110 and 170 of the field emission device 100 of FIG. 1. FIG. 3 is a view illustrating an anode terminal part included in the field emission device of FIG. 1.

Referring to FIG. 1, the field emission device 100 includes the first substrate 110 on which a stacked structure 120 including electron emission sources is formed; the second substrate 170 facing and spaced apart from the first substrate 110 and on which an anode 172 and a phosphor layer 174 are sequentially formed; and a side frame 130 that surrounds an area between the first substrate 110 and the second substrate 170 and forms a sealed internal space.

Detailed features of the stacked structure 120 formed on the first substrate 110 and the stacked structures formed on the second substrate 170 and emission performed by the structures will now be described with reference to FIG. 2.

Referring to FIG. 2, a plurality of gate electrode lines 122 are formed on the first substrate 110. An insulating layer 124 is formed on the gate electrode lines 122, and a plurality of cathode lines 126 are formed on the insulating layer 124. A longitudinal direction of the gate electrode lines 122 may be perpendicular to a longitudinal direction of the cathode lines 126. A plurality of electron emission sources 128 are formed on each cathode line 126. In particular, the plurality of electron emission sources 128 may be formed on portions of the cathode line 126 where the gate electrode lines 122 and the cathode line 126 cross over each other. The electron emission sources 128 emit electrons by an electric field formed between the gate electrode lines 122 and the cathode lines 126. For example, the electron emission sources 128 may be formed of carbon nanotubes (CNTs), amorphous carbons, nanodiamonds, nano metal wires, and nano oxide metal wires. The disposition of the gate electrode lines 122, the cathode lines 126, and the electron emission sources 128 is not limited to the exemplary embodiment described above, and may be in various forms. For example, the cathode lines 126, the insulating layer 124, and the gate electrode lines 122 may be sequentially formed on the first substrate 110, holes are formed in the gate electrode lines 122 and the insulating layer 124, and the electron emission sources 128 are formed on the cathode lines 126 through the holes.

The anode 172 and the phosphor layer 174 are sequentially formed on the second substrate 170. The second substrate 170 is formed of a transparent material, for example, glass. A high voltage is applied to the anode 172 to accelerate the electrons emitted from the electron emission sources 128. The anode 172 may be formed of a transparent material that allows visible rays to pass through. For example, the anode 172 may be formed of a transparent electrode material, such as indium tin oxide (ITO) or indium zinc oxide (IZO). The phosphor layer 174 may be formed of a phosphor material that emits white light when excited. Alternatively, the phosphor layer 174 may be divided into a plurality of cell regions, and each cell region may be formed of a phosphor material that emits red light, green light, or blue light when excited.

The field emission device 100 may further include a spacer (not shown) disposed between the first substrate 110 and the second substrate 170 so as to maintain a space therebetween.

When a voltage is applied between any one of the plurality of gate electrode lines 122 and any one of the plurality of cathode lines 126, electrons are emitted from the corresponding electron emission source 128 formed on the portion of the cathode line 126 where the gate electrode line 122 and the cathode line 126 to which the voltage is applied cross over each other. The emitted electrons are accelerated by a high voltage that is applied to the anode 172. The accelerated electrons excite the phosphor layer 174, and to emit rays. A wavelength band of the excited visible rays is determined depending on the material of the phosphor layer 174. When the field emission device 100 is used as a field emission-type backlight, the phosphor layer 174 is formed of a phosphor material that emits white light when excited. When the field emission device 100 is used as a display device, the phosphor layer 174 is divided into a plurality of cell regions corresponding to pixels, and the cell regions each formed of a phosphor material that emit red light, green light, or blue light when excited are alternately disposed with respect to each other.

Referring back to FIG. 1, the first substrate 110 is offset from the second substrate 170 by a predetermined length in a first direction. The first direction is an X-axis direction that is perpendicular to a direction where the first substrate 110 and the second substrate 150 are spaced apart from each other (i.e., Z-axis direction in FIG. 1). Due to such disposition, a rear terminal part 119 for applying a voltage to the gate electrode lines 122 and the cathode lines 126 is provided on a protruding region 110a protruding by the predetermined length. The rear terminal part 119 is connected to an external printed circuit board (PCB) via a flexible printed circuit (FPC). As illustrated in FIG. 2, a longitudinal direction of any one of the gate electrode line 122 and the cathode line 126 may be the first direction, and a longitudinal direction of the other thereof may be a second direction that is perpendicular to the first direction. In this case, the field emission device 100 may further include a routing pattern on the first substrate 110 so as to guide any one of the gate electrode line 122 and the cathode line 126 towards the protruding region 110a. A structure of the routing pattern is disclosed in Korean Patent Application No. 10-2010-0025308 filed by the same applicant, and the disclosure thereof can be incorporated herein by reference.

In addition, an end of an anode terminal part 140 for applying a voltage to the anode 172 contacts the anode 172, and the other end thereof is exposed outside of the side frame 130. The anode terminal part 140 may penetrate through the side frame 130 as illustrated in FIG. 1, and a detailed description of the structure of the anode terminal part 140 will now be described with reference to FIG. 3. The anode terminal part 140 includes a contact plate 142, an internal pin 144 connected to the contact plate 142, an anode pin 146 which is connected to the internal pin 144, and an external pin 148 connected to the anode pin 146. The contact plate 142 contacts the anode 172 formed on the second substrate 170, and may be in a sus mesh form. The anode pin 146 is made of a flexible and conductive material. As illustrated in FIG. 1, the anode pin 146 may be in a bent form, and penetrates through the side frame 130 at a position indicated by P. The anode pin 146 may be made of a dumet. The external pin 148 is connected to the anode pin 146 outside of the side frame 130. The external pin 148 may be connected to an external high voltage terminal via a connector.

This structure of the anode terminal part 140 may be easily formed by a hot-melt adhesion process of the side frame 130. In a general process of forming the side frame 130, cross-sections of an adhesion line L of the side frame 130 that has been initially divided into two parts are attached to each other. In this regard, the anode pin 146 is inserted between the cross-sections of the adhesion line L of the side frame 130 before the attachment, and the cross-sections thereof are then attached to each other. As a result, the anode pin 146 has a structure of penetrating through the side frame 130.

The structure of the field emission device 100 in which the first substrate 110 is offset from the second substrate 170 by a predetermined length in a direction and the anode terminal part 140 is included therein is provided to decrease non-emission areas with respect to a total size of the field emission device 100, as possible. In the related art, a gate electrode terminal, a cathode terminal, and an anode terminal respectively protrude towards three different side surfaces of a panel. To form such structure, a rear substrate is offset from a front substrate by a predetermined length in two directions that are perpendicular to each other, and protruding regions formed in this manner become non-emission regions. On the other hand, according to an exemplary embodiment, a gate electrode terminal, a cathode terminal, and an anode terminal protrude in the same direction, and thus non-emission regions decrease.

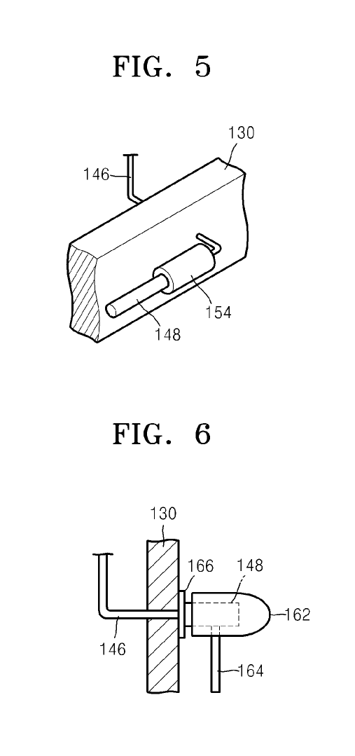

FIGS. 4, 5 and 6 are views illustrating structures of reinforcing portions of the anode terminal part of the field emission device of FIG. 1, wherein the portions of the anode terminal part are exposed to the outside.

Referring to FIG. 4, a reinforcing glass member 152 is disposed on an outer wall of the side frame 130. The end of the anode pin 146 that is exposed to the outside and the external pin 148 are supported by the reinforcing glass member 152.

Referring to FIG. 5, the external pin 148 is inserted through a sus pipe 154. Customized products in various sizes may be used as the sus pipe 154.

Referring to FIG. 6, a frit 166 is formed between the external pin 148 and a portion of the anode pin 146 that penetrates through the side frame 130 to be exposed to the outside. The external pin 148 is connected to a cable 164 via a connector 162.

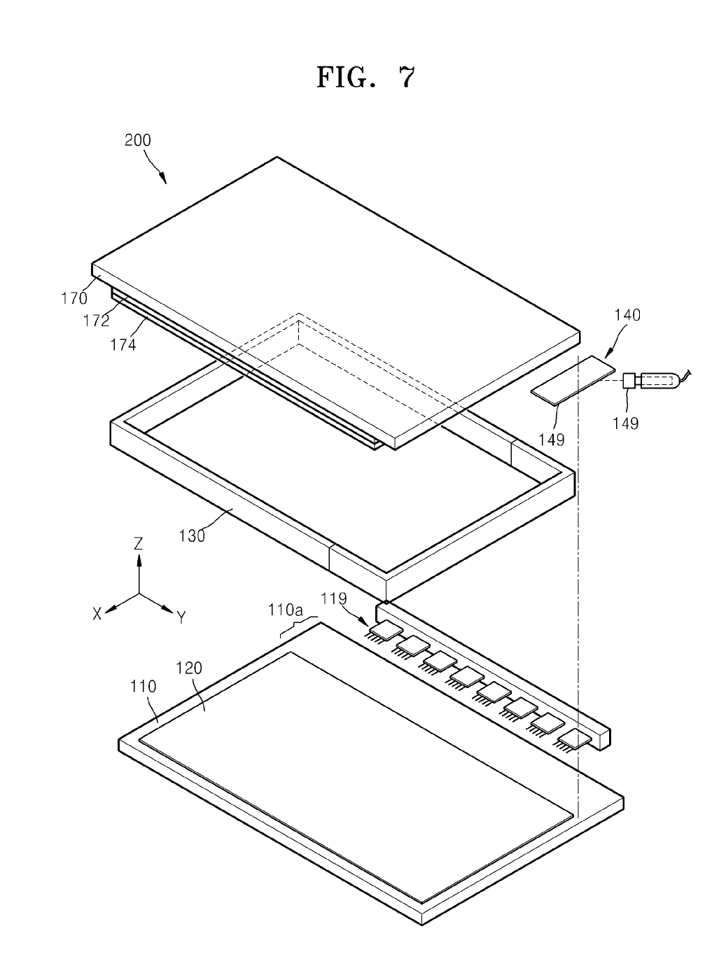

FIG. 7 is a schematic exploded perspective view of a field emission device 200 according to another exemplary embodiment. In the present exemplary embodiment, the structure of the anode terminal part 140 is different from that of the anode terminal part 140 of the field emission device 100 of FIG. 1. The anode terminal part 140 is formed of a metal plate 149 which contacts the anode 172 and that is disposed to penetrate through a contact area between the side frame 130 and the second substrate 170. A portion of the metal plate 149 that is exposed to the outside of the side frame 130 may be wound in a cylindrical form and connected to an external cable via a socket (not shown).

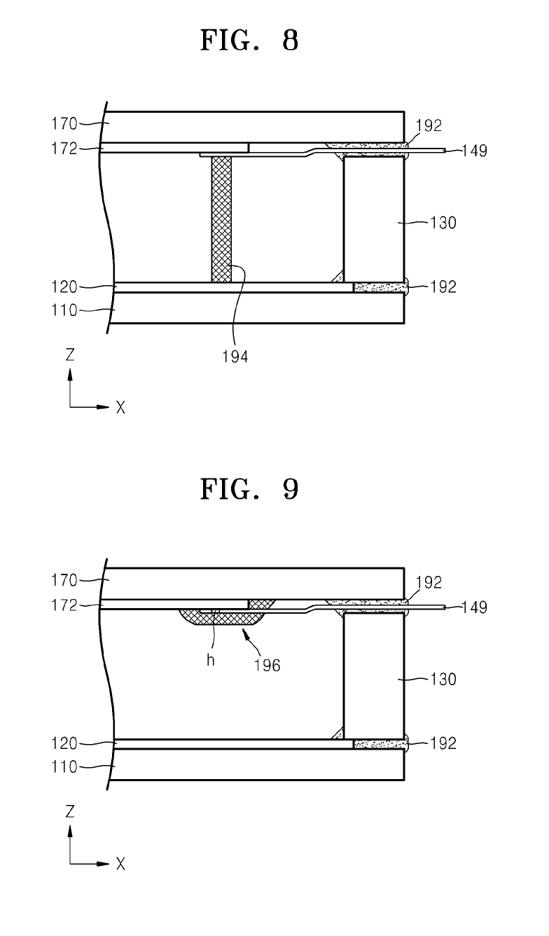

FIGS. 8 and 9 are partial cross-sectional views illustrating structures in which a metal plate 149 included in the field emission device 200 of FIG. 7 is attached to an anode.

Referring to FIG. 8, the side frame 130, the second substrate 170, and the metal plate 149 are fixedly attached to each other by a frit 192. In addition, the field emission device 200 includes a spacer 194 that maintains a space between the first substrate 110 and the second substrate 170, and the metal plate 149 is fixedly attached to the anode 172 by the spacer 194. In other words, the second substrate 170 and the metal plate 149 are pressed by vacuum pressure in the internal space surrounded by the side frame 130 by using the spacer 194, thereby allowing the metal plate 149 to be fixedly attached to the anode 172.

Referring to FIG. 9, the side frame 130, the second substrate 170, and the metal plate 149 are fixedly attached to each other by the frit 192. In addition, the metal plate 149 may be attached to the anode 172 by a conductive adhesive 196. A surface black layer (not shown) may be formed on portion of the metal plate 149 that contacts the frit 192 to maintain an airtight fit with the frit 192. A hole (h) may be formed in a portion of the metal plate 149 that contacts the anode 172 to enhance contact properties therebetween.

While exemplary embodiments have been particularly shown and described, it will be understood by those of ordinary skill in the art that various changes in form and details may be made therein without departing from the spirit and scope of the inventive concept as defined by the following claims.

What is claimed is:

1. A field emission device comprising:
a first substrate on which at least one gate electrode line, at least one cathode line, and at least one electron emission source are formed;
a second substrate on which an anode and a phosphor layer are formed;
a side frame which is interposed between the first substrate and the second substrate and surrounds an area between the first substrate and the second substrate to form a sealed internal space, wherein the first substrate is offset from the second substrate by a predetermined length in a first direction perpendicular to a direction in which the first substrate and the second substrate are spaced apart from each other by the side frame;
a rear terminal part through which a voltage is applied to the gate electrode line and the cathode line, and which is formed on a protruding region of the first substrate protruding by the predetermined length; and
an anode terminal part through which a voltage is applied to the anode, wherein the anode terminal has a first end which contacts the anode, and a second end which is exposed to outside of the side frame.

2. The field emission device of claim 1, wherein the anode terminal part penetrates through the side frame.

3. The field emission device of claim 2, wherein the anode terminal part comprises:
a contact plate which contacts the anode;
an internal pin which is connected to the contact plate;
an anode pin which is connected to the internal pin, and penetrates through the side frame, the anode pin being formed of a flexible and conductive material; and
an external pin which connected to the anode pin outside of the side frame.

4. The field emission device of claim 3, wherein the anode pin comprises a dumet.

5. The field emission device of claim 3, wherein the contact plate comprises a sus mesh.

6. The field emission device of claim 3, further comprising a reinforcing glass member which is attached to an outer wall of the side frame and supports the external pin.

7. The field emission device of claim 3, further comprising a sus pipe surrounding the external pin.

8. The field emission device of claim 3, further comprising a frit formed between the external pin and a portion of the anode pin that penetrates through the side frame to be exposed to the outside.

9. The field emission device of claim 1, wherein the anode terminal part comprises a metal plate penetrating through a contact region between the side frame and the second substrate.

10. The field emission device of claim 9, wherein the side frame, the second substrate, and the metal plate are fixedly attached to each other by a frit.

11. The field emission device of claim 9, comprising a spacer which maintains a space between the first substrate and the second substrate, wherein the metal plate is fixedly attached to the anode by the spacer.

12. The field emission device of claim 9, wherein the metal plate is attached to the anode by a conductive adhesive.

13. The field emission device of claim 12, wherein the side frame, the second substrate, and the metal plate are fixedly attached to each other by a frit.

14. The field emission device of claim 13, wherein a surface black layer is formed on a portion of the metal plate that contacts the frit.

15. The field emission device of claim 12, wherein the metal plate has a hole formed in a portion that is attached to the anode.

16. The field emission device of claim 1, wherein a longitudinal direction of one of the gate electrode line and the cathode line is the first direction, and a longitudinal direction of the other one of the gate electrode line and the cathode line is a second direction perpendicular to the first direction.

17. The field emission device of claim 16, wherein the first substrate includes a routing pattern for guiding one of the gate electrode line and the cathode line towards the protruding region protruding by the predetermined length, and a longitudinal direction of the one of the gate electrode line and the cathode line is the second direction.

18. The field emission device of claim 1, wherein the phosphor layer comprises a phosphor material which emits white light when excited by electrons emitted from the electron emission source.

19. The field emission device of claim 1, wherein the phosphor layer comprises a first cell region comprising a phosphor material which emits red light when excited by electrons emitted from the electron emission source, a second cell region comprising a phosphor material which emits green light when excited by electrons emitted from the electron emission source, and a third cell region comprising a phosphor material which emits blue light when excited by electrons emitted from the electron emission source.
